(19) United States
(12) Patent Application Publication
(10) Pub. No.: US 2015/0034462 A1
(43) Pub. Date: Feb. 5, 2015

(54) ON-LOAD TAP CHANGER

(71) Applicant: MASCHINENFABRIK REINHAUSEN GMBH, Regensburg (DE)

(72) Inventors: Alfred Bieringer, Geiselhoering (DE); Christian Hammer, Regensburg (DE); Rolf Strempel, Regensburg (DE)

(21) Appl. No.: 14/379,768

(22) PCT Filed: Mar. 25, 2013
(86) PCT No.: PCT/EP2013/056279

§ 371 Date: Aug. 20, 2014

(30) Foreign Application Priority Data
Mar. 25, 2012 (DE) 202012101475.0

(51) Int. Cl. H01H 3/42; H01H 9/00; H01H 3/40

(52) U.S. Cl. CPC H01H 3/42; H01H 3/40; H01H 9/0027; H01H 9/0016; H01H 2231/052
USPC 200/16 R

(57) ABSTRACT

The invention relates to an on-load tap changer for switching among different winding taps of a step transformer without interruption according to the preamble of the first patent claim. The general inventive concept lies in actuating both the selector contact unit and the switching means for uninterrupted load switching by means of a common motor drive without an energy store being connected therebetween.

The present invention relates to an on-load tap changer for uninterrupted switching between different winding taps of a tapped transformer in accordance with the preamble of the first claim.

On-load tap changers have been in use worldwide on a large scale for many years for uninterrupted switching between different winding taps of tapped transformers. So-called reactor switches, which are particularly widespread in North America, have a switch-over reactance that enables a slow, continuous switching. On-load tap changers according to the resistance fast switching principle usually consist of a selector for power-free selection of the respective winding tap of the tapped transformer that is to be switched over to and a load changeover switch for the actual changing over from the previous to the new, preselected winding tap. The load changeover switch for that purpose usually comprises switch contacts and resistance contacts. The switch contacts in that case serve for direct connection of the respective winding tap with the load diverter and the resistance contacts for temporary connection, i.e. bridging by one or more switching-over resistances. However, developments in recent years have led away from load changeover switches with mechanical switching contacts in insulating oil. Instead, vacuum interrupters are increasingly employed as switching elements.

An on-load tap changer of that kind with vacuum interrupters is disclosed in, for example, DE 10 2009 043 171 [US 2003/0139510]. Here, a load changeover switch carries a drive shaft, which is drivable by a force-storing device, with at least one cam disk. The cam disk has a plurality of cams, wherein two cams arranged at the cam disk at the end have a profile, which departs from the circular shape, in the form of lobes at which a respective roller, which is connected with a vacuum interrupter by way of a rocker arm and that scans the profiled contour of the respective cam, is guided with maintained contact.

In one specific category of on-load tap changer, i.e. so-called load selectors, the described means for selection of a new winding tap and the means for the actual load changeover are constructionally combined and actuated in common. Tap changers according to the principle of resistance fast switching for uninterrupted switching from one winding tap at the tapped transformer to another are usually constructed so that the respective fixed tap contacts electrically connected with the output lines of the tap windings are arranged in one or more horizontal planes circularly at an insulating-material frame or cylinder and are connectable by rotatable contact bridges actuated by concentric drive shafts. In the case of load selectors in which the tap selection and the actual load switching are combined, actuation of the contact bridges in that case takes place abruptly after triggering of a force-storing device, usually a spring-force store, drawn up by the drive shaft of the switch.

In departure from these usual constructions, a tap changer with linear contact actuation is described in DE 42 37 165 [U.S. Pat. No. 5,523,674], wherein the fixed tap contacts extend along a track in the interior of the switch and are connectable by a displaceable switching mechanism that in turn is driven by the drive shaft. The vertically displaceable switching mechanism in that case consists of a draw-up carriage that is continuously drivable by the drive shaft and that preselects the new fixed tap contact, and a drive output part that can be drawn up by the draw-up carriage by a force-storing device and that after triggering abruptly runs after the draw-up carriage and in that case executes the actual load changeover from the previous tap of the tapped winding to the preselected new tap. The switch elements required for that purpose are a component of the output drive part.

A further on-load tap changer, which is attributable to the applicant, with linearly arranged selector contacts has become known from DE 198 47 745. Disposed above the selector contacts, is thus locally separated, are the stationary vacuum interrupters that are associated with the respective selector contacts of each phase, for the actual, abrupt load changeover. A spring force-storing device is necessary for actuation of this on-load tap changer that store actuates the selector contacts during its drawing up movement as well as the vacuum switching elements by its abrupt drive output movement.

Regardless of the constructional form of the on-load tap changer, thus with rotating or linearly movable contact system, a spring-force-storing device for abrupt switching by the contact system is needed in on-load tap changers known from the prior art.

Force-storing devices known from the prior art have to be drawn up, i.e. stressed, at the start of each actuation of the on-load tap changer by a drive shaft. The known force-storing devices essentially consist of a draw-up carriage and a jump carriage, between which force-storage springs as force-storing devices are arranged. Force-storing devices of that kind can be inferred from, for example, DE 198 55 860 and DE 28 06 282 [GB 2,614,794].

An initial slow rotation of the drive shaft is employed so as to draw up a draw-up carriage in a straight line in order to subsequently transfer the again straight-line movement of the jump carriage into a rotational main movement of the drive output shaft and into an actual contact actuation connected therewith. This complicated conversion of rotation into a straight-line movement and back again into rotation requires a large amount of space for the force-storing device construction within the on-load tap changer and in addition a multiplicity of complex individual subassemblies.

The object of the present invention is therefore to indicate an on-load tap changer that dispenses with the complicated construction of a force-storing device and thus offers a significantly simplified form of constructional with, at the same time, increased operational reliability.

This object is fulfilled by an on-load tap changer for uninterrupted switching between different winding taps of a tapped transformer with the features of the first claim. The subclaims in that case relate to particularly advantageous developments of the invention.

The general inventive idea consists in actuating not only the selector contact unit, but also the switching means for the uninterrupted load changeover by a common motor drive without interposition of a force-storing device.

According to a preferred form of embodiment of the invention both the threaded spindle, which in turn is operatively connected with the selector contact unit, and a camshaft, by way of which the switching means for uninterrupted switching is actuatable, are driven by the motor drive. This makes possible, in particularly advantageous manner, simple independent actuation of the selector contact unit by the switching means for the uninterrupted switching.

According to a further preferred form of embodiment of the invention the on-load tap changer comprises a transmission module that is fastened to the underside of the transformer cover and that co-operates with the motor drive arranged at the opposite, is outer side of the transformer cover. The transmission module has, for that purpose, a flange-like sealing module that is arranged directly at the underside of the transformer cover and that is detachably connected, in particular screw connected, with the motor drive. In addition, the entire load changeover switch is attached to the transmission module. The transmission module thus has not only the task of mounting the on-load tap changer, but also sealing relative to the outer side of the transformer by the sealing module. Twistings of the transformer cover during transport of the transformer are thus not transmitted to the on-load tap changer. In addition, a connecting flange with a milled sealing surface at the transformer cover can thus be eliminated. Beyond that, this form of proposed fastening offers to the transformer manufacturer simple mounting of the on-load tap changer within the transformer vessel.

According to a further preferred form of embodiment of the invention a support plate of a dielectric material, particularly a synthetic material, is provided, at which the selector contact unit is arranged on a first side and the switching means for uninterrupted switching is arranged on a second side in such a manner that the support plate produces the spacing from ground necessary for the on-load tap changer.

According to yet a further form of embodiment of the invention the at least one selector contact unit is moved during a switching process along a guide rod that ensures linear guidance of the at least one selector contact unit. In that case, a selector contact unit comprises a respective slide carriage as well as a contact support for receiving the movable selector contacts that co-operate with the fixed selector contacts.

According to again a further form of embodiment of the invention the movable selector contacts are respectively received at a contact support and co-operate with the fixed selector contacts in such a manner that the individual fixed selector contacts are connectable by a longitudinal displacement of the movable selector contacts inclusive of slide carriage, thus the selector contact unit, along the guide rod. Through movement of the selector contact unit to and/or fro the individual fixed selector contacts are connected and thus run through the regulating range of the on-load tap changer.

The invention and its advantages are described in more detail in the following with reference to the accompanying drawings, in which:

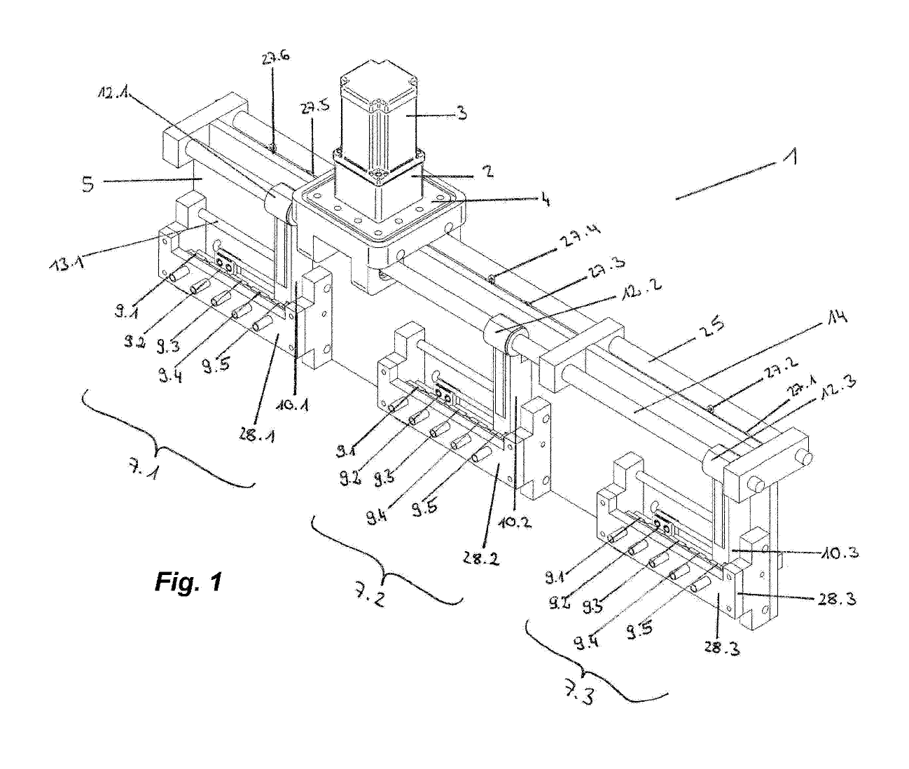

FIG. 1 shows a first side perspective view of one form of an on-load tap changer according to the invention,

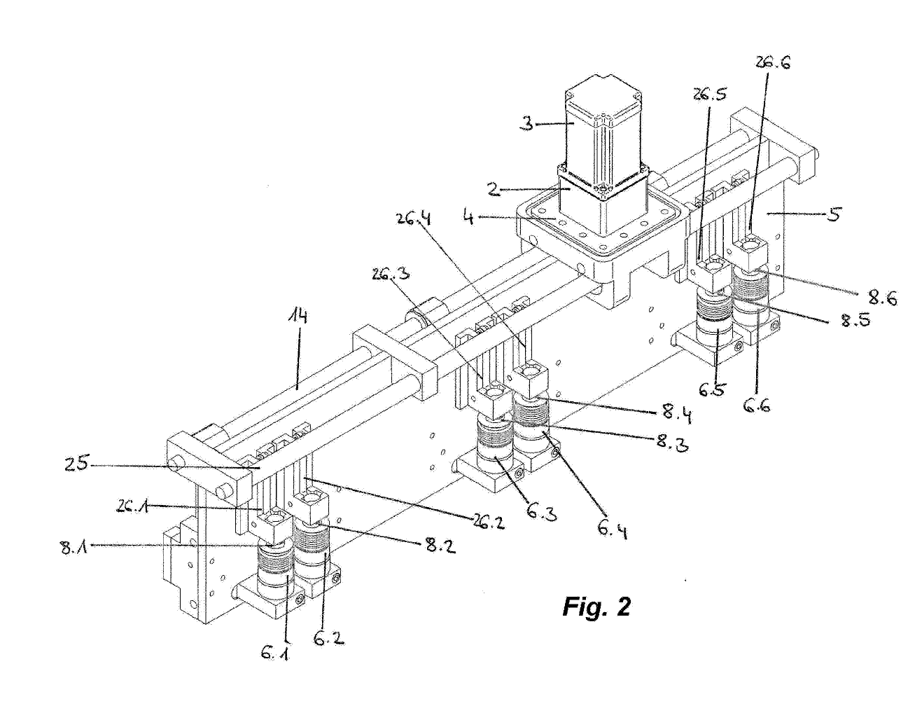

FIG. 2 shows a second side perspective view in accordance with the form of embodiment according to FIG. 1, and

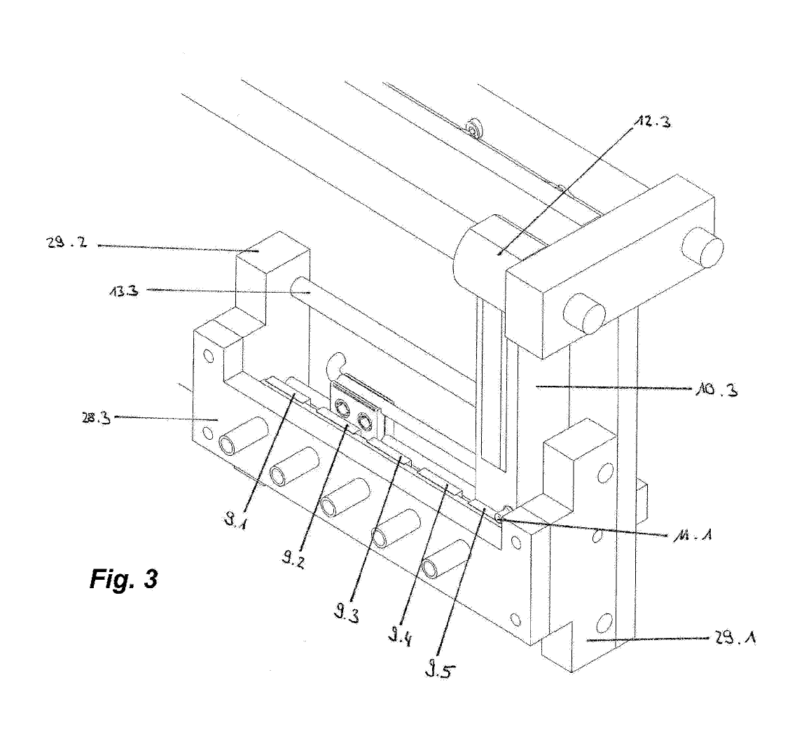

FIG. 3 shows a detail view of the selector contact unit of an on-load tap changer according to the invention.

An on-load tap changer 1 according to the invention is shown in FIGS. 1 and 2 in two different perspective views, which tap changer is arranged directly below a transformer cover, which is not shown, of a tapped transformer that is similarly not illustrated in more detail. A more precise description of the components of the on-load tap changer 1 and the function thereof can be inferred from the description of the FIGS. further below. A tapped transformer of that kind, which is well-known from the prior art, comprises a transformer vessel that is filled with insulating oil and in which at least one winding is arranged at an iron yoke. This winding is divided into a main winding and a regulating winding, at which a plurality of winding taps forming the regulating range is provided. In addition, the on-load tap changer 1 comprises a transmission module 2 that is attached to the underside of the transformer cover and that co-operates with a motor drive 3 arranged at the opposite, outer side of the transformer cover. The motor drive 3 can in that case be constructed as, for example, a proprietary step motor. The transmission module comprises a flange-like sealing module 4 that is arranged directly at the underside of the transformer cover and detachably connected, in particular screw-connected, with the motor drive 3. The entire on-load tap changer 1 is thus fastened to the transmission module 2. The transmission module 2 fulfils both the task of mounting the on-load tap changer 1 and the task of hermetically sealing relative to the outer side of the transformer by the sealing module 4. Twistings of the transformer cover during transport of the transformer are thereby not transmitted to the on-load tap changer 1.

A support plate 5 of dielectric material, to which individual subassemblies of the on-load tap changer 1 are fastenable, is mechanically connected with the transmission module 2. The support plate 5 is in that case made of electrically is insulating material and constructed for the purpose of receiving all significant components of the on-load tap changer 1. The on-load tap changer 1 according to the invention provides, as switching means for the uninterrupted switching, vacuum interrupters 6.1 . . . 6.6, wherein in each instance two vacuum interrupters 6.1 and 6.2 or 6.3 and 6.4 or 6.5 and 6.6 are respectively associated with a phase of the on-load tap changer 1 and co-operate with a corresponding selector contact unit 7.1 . . . 7.3 of the same phase. The vacuum interrupters 6.1 . . . 6.6 are switching means, which are known from the prior art, with a movable switch contact 8.1 . . . 8.6 and a fixed contact (not illustrated in more detail). Each selector contact unit 7.1 . . . 7.3 comprises a respective plurality of connectable fixed selector contacts 9.1 . . . 9.5 that are electrically connected with the winding taps of the regulating winding of the tapped transformer, a contact support 10.1 . . . 10.3 with two respective resiliently mounted, movable selector contacts 11.1 and 11.2, and two respective vacuum interrupters 6.1 . . . 6.6.

Shown in the illustration of FIG. 1 by way of example are three selector contact units 7.1, 7.2 and 7.3; each selector contact unit 7.1, 7.2 and 7.3 is in that case connected with a separate phase, thus winding, of the tapped transformer. The contact support 10.1 . . . 10.3 of each phase is in that case mechanically fixed to a slide carriage 12.1 . . . 12.3 and forms together therewith a constructional unit. The slide carriage 12.1 . . . 12.3 is received at a guide rod 13.1 . . . 13.3 as well as at a threaded spindle 14, which is arranged parallel to the guide rod 13.1 . . . 13.3, in such a manner that the individual fixed selector contacts 9.1 . . . 9.5 are connectable by a longitudinal displacement of the movable contacts 11.1 . . . 11.2 together with slide carriage 12.1 . . . 12.3 along the threaded spindle 14. Depending on the switching principle, thus according to the reactor switching principle or resistance fast switching principle, in that case middle settings—in which one movable selector contact, for example the movable selector contact 11.1, connects the first fixed selector contact, for example the fixed selector contact 9.1, and the other movable selector contact, for example the movable selector contact 11.2, connects the second fixed selector contact, for example the fixed selector contact 9.2, adjacent to the first fixed selector contact—are permissible as stationary operational setting of the on-load tap changer 1. Thus, in accordance with the reactor switching principle with, here, five illustrated fixed selector contacts 9.1 . . . 9.5, nine stationary operational settings are possible, whereas in the case of an on-load tap changer 1 according to the resistance fast switching principle, in which no middle settings are permissible, there are only five stationary operational settings.

Not only the threaded spindle 14 that in turn is in mechanical operative connection with each of the selector contact units 7.1 . . . 7.3, but also a camshaft 25, by means of which the switching means for the uninterrupted switching - thus the vacuum interrupters 6.1 . . . 6.6—are actuatable, are driven by the motor drive 3. The threaded spindle 14 is constructed over the entire length thereof as a threaded spindle and is so brought into engagement with a spindle nut 16.1 . . . 16.3, which is provided in each of the slide carriages 12.1 . . . 12.3, but not shown in FIGS. 1 and 2, that each slide carriage 12.1 . . . 12.3 moves horizontally when rotation of the threaded spindle 14 takes place. For actuation of the vacuum interrupters 6.1 . . . 6.6 each movable switch contact 8.1 . . . 8.6 is mechanically constrainedly coupled with a stroke rod 26.1 . . . 26.6, which co-operates with cam lobes 27.1 . . . 27.6 that are arranged on the camshaft 25 to be opposite the respective switch contacts 8.1 . . . 8.6, in such a manner that on rotation of the camshaft 25 the cam lobes 27.1 . . . 27.6 introduce a vertical movement into the corresponding stroke rod 26.1 . . . 26.6 and thus ultimately actuate the associated movable switch contact 8.1 . . . 8.6 of the corresponding vacuum interrupters 6.1 . . . 6.6. A rocker arm arrangement drivable by the camshaft could also be provided as a technical alternative to actuation of the vacuum interrupters by the stroke rod. Depending on the switching sequence on which the on-load tap changer 1 is based a plurality of cam lobes 27.1 . . . 27.6 per vacuum interrupter 6.1 . . . 6.6 is in that case provided at the circumference of the camshaft 25.

FIG. 3 shows the fixed selector contacts 9.1 . . . 9.5 that are arranged at a contact strip 28.1 of plastics material. The contact strip 28.1 . . . 28.3 is fastened to the support plate 5 by two respective spacers 29.1 . . . 29.2 that are used as connection of a switch-over choke (not illustrated) or a switch-over resistor. Switch-over chokes are provided in accordance with the reactor switching principle and switch-over resistances according to the resistance fast switching principle. In addition, the contact strip 28.1 has at its longitudinal side a control link at which several lobes are arranged on both sides in order to vertically move the resiliently mounted selector contacts 11.1 and 11.2 of the corresponding selector contact unit 7.1 in the case of longitudinal displacement of the corresponding slide carriage 12.1 by the lobes, which are provided at the control link, in dependence on the profile of the plurality of lobes. The profile of the lobes is in that case dimensioned so that the movable selector contacts 11.1 and 11.2 of the selector contact unit 7.1 between two adjacent fixed selector contacts 9.1 . . . 9.5 lift off the currently connected fixed selector contact, here 9.1, since they again connect, after a completed switching process, the next fixed selector contact, here 9.2. Thus, a middle setting of the movable selector contacts 11.1 and 11.2 at two adjacent fixed selector contacts 9.1 . . . 9.5 is permissible in accordance with the reactor switching principle, whereas in accordance with the resistance fast switching principle there is onward switching to the adjacent fixed selector contact. The contact members 11.1 and 11.2 are formed to be spherical at the actual contact surface for defined contact-making.

In summary, it can be emphasized that the on-load tap changer 1 according to the invention is usable not only in accordance with the reactor switching principle, but also in accordance with the resistance fast switching principle. Depending on the underlying switch-over principle, in the case of the, here, five illustrated fixed selector contacts 9.1 . . . 9.5 in accordance with the reactor switching principle nine stationary operating settings are permissible, whereas in the case of an on-load tap changer 1 according to the invention constructed in accordance with the resistance fast switching principle merely five stationary operational settings are permissible.

The on-load tap changer 1 according to the invention can be used with particular advantage at distributing transformers for voltage regulation of local mains.

### REFERENCE NUMERAL LIST

1 on-load tap changer
2 transmission module
3 motor drive
4 sealing module
5 support plate
6.1 . . . 6.6 vacuum interrupters
7.1 . . . 7.3 selector contact units
8.1 . . . 8.6 movable switch contacts
9.1 . . . 9.5 fixed selector contacts
10.1 . . . 10.3 contact supports
11.1, 11.2 movable selector contacts
12.1 . . . 12.3 slide carriages
13.1, 13.2 guide rods
14 threaded spindle
16.1 . . . 16.3 spindle nuts
25 camshaft
26.1 . . . 26.6 stroke rods
27.1 . . . 27.6 cam lobes
28.1 . . . 28.3 contact strips
29.1 . . . 29.3 spacers

1. An on-load tap changer for uninterrupted switching between different winding taps of a tapped transformer wherein
at least one selector contact unit with a plurality of fixed selector contacts that are respectively electrically connected with the individual winding taps is arranged along a line,
the fixed selector contacts are actuatable by two longitudinally displaceable movable selector contacts,
for the uninterrupted switching two vacuum interrupters are provided for each phase, and
a motor drive for introducing a drive movement into the on-load tap changer is provided, and
the at least one selector contact unit and the switching means for the uninterrupted switching are so directly actuatable by the common motor drive that introduction of the drive movement of the motor drive into the at least one selector contact unit and the switching means for the uninterrupted switching (takes place without interposition of a force-storing device.

2. The on-load tap changer according to claim 1, wherein the motor drive drives both a threaded spindle that in turn is operative connected with the selector contact unit, and a camshaft, by way of which the switching means for the uninterrupted switching is actuatable, in such a manner that both the movable selector contacts and the switching means for the uninterrupted switching are actuatable.

3. The on-load tap changer according to claim 1, wherein the entire load changeover switch is arranged by a transmission module at the underside of a transformer cover.

4. The on-load tap changer according to claim 1, wherein the transmission module comprises a flange-like sealing module.

5. The on-load tap changer according to claim 1, wherein a support plate of a dielectric material, at the first side of which the at least one selector contact unit and at the second side of which the switching means for the uninterrupted switching are arranged, is provided.

6. The on-load tap changer according to claim 1, wherein the at least one selector contact unit comprises a respective slide carriage, a respective contact support and respective movable selector contacts that co-operate with at least one fixed selector contact.

7. The on-load tap changer according to claim 1, wherein the respective slide carriage is received by a guide rod and the threaded spindle.

8. The on-load tap changer according to claim 1, wherein the movable selector contacts are each received in a respective contact support and co-operate with fixed selector contacts arranged at a contact strip.

9. The on-load tap changer according to claim 1, wherein the at least one selector contact unit is arranged to be so displaceable along the guide rod and the threaded spindle by the respective slide carriage that it is thereby possible to run through the regulating range of the on-load tap changer.

10. The on-load tap changer according to claim 1, wherein the movable selector contacts of a phase in each stationary operational setting connect at least one fixed selector contact of the same phase of the on-load tap changer.

11. The on-load tap changer according to claim 1, wherein two respective movable selector contacts are received in a contact support to be resiliently mounted.

12. The on-load tap changer according to any claim 1, wherein the fixed selector contacts are arranged at a contact strip, which contact strips are in turn fastened to the support plate by respective spacers.

13. The on-load tap changer according to claim 1, wherein the movable switch contacts of the corresponding vacuum interrupters are each so operatively connected by way of a stroke rod with cam lobes provided at the camshaft that the respective vacuum interrupter is connectable when rotation of the camshaft takes place.

14. The on-load tap changer according to claim 1 for use in voltage regulation of a distributing transformer.
